(19) United States
(12) Patent Application Publication
(10) Pub. No.: US 2006/0152802 A1
(43) Pub. Date: Jul. 13, 2006

(54) Twin image screen

(75) Inventors: Yaw-Huei Tsai, (US); Ya-Cheng Tzeng, (US); Kuang-Lung Ko, (US)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/328,165

(22) Filed: Jan. 10, 2006

(30) Foreign Application Priority Data
Jan. 13, 2005 (TW) 094101053

(51) Int. Cl. G03B 21/60

(52) U.S. Cl. 359/452

(57) ABSTRACT

A twin image screen includes a transparent substrate, a first diffuser and a second diffuser. In this case, the first diffuser is disposed at one side of the transparent substrate. The second diffuser is disposed at another side of the transparent substrate.

### BACKGROUND OF THE INVENTION

1. Field of Invention

The invention relates to a screen and, in particular, to a twin image screen.

2. Related Art

Conventional projector display devices are divided into the front projection and the rear projection by their projection types. As shown in FIG. 1 and FIG. 2, the front projection means the projector A and the observer P are at the same side of the projection screen 1. In the other way, the rear projection means the projector A and the observer P are at the different and opposite sides of the projection screen 1′.

Presently, the front projection type is more common, so that people see light, which is projected to the projection screen 1 by the projector A, and then reflected by the projection screen 1. The light of the projector 1 is transmitted in the observation space. By this way, only when the environment is dark, the quality of the image will be good. When the environment is full of other light, the image come from the projector will be unclear. There are some users conducted the projected light to a curtain or a flat wall. Although it is more convenient to see image without a projection screen 1, there is usually wrinkles on the curtain and the curtain will be blown by wind. Meanwhile, the quality of the image projected on the wall is often worse, owing to the color and the uneven surface of the wall.

On the other way, with the rear projection, people see light projected by the projector A and then transmitted out of the projection screen 1. The projected light is transmitted in a close space of the projector A, and the light will not be affected by environment. As a result, the contrast of the image will be increased, and the color and the uniformity of the image will be better. Even in a bright environment, the rear projection projector will not be limited.

Traditionally, the projection screen 1 of the rear projection mainly includes a fresnel lens sheet and a lenticular lens sheet. Because of the complexity of the optical lens sheet structure, the cost of the projection screen 1′ is higher.

When a trade show, a product advertisement or a meeting is proceeding, for all the audience to see the image from every direction, there will be a need to use two or more projection screens. However, no matter the projection screen 1 or 1′ is a front or rear projection type, it can not achieve the goal to obtain clear images at both sides of the projection screen. As a result, more projection screens should be bought and the more money is waste. Although the prior art used the front projection technique to project the image on the curtain, which also obtain images at both sides of the screen, the resolution is not good, the image is not clear and the viewing angle is not ideal.

Therefore, it is an important subject of the invention to provide a projection screen with clear images at both sides.

### SUMMARY OF THE INVENTION

In view of the foregoing, the invention is to provide a projection screen with clear images at both sides.

To achieve the above, a twin image screen includes a transparent substrate, a first diffuser and a second diffuser. In this case, the first diffuser is disposed at one side of the transparent substrate. The second diffuser is disposed at another side of the transparent substrate.

As mentioned above, the twin image screen of the invention can make the audiences at two sides of the screen to see the clear images simultaneously. Compared with the prior art, the twin image screen of the invention has the first diffuser and the second diffuser disposed at two sides of the transparent substrate. Owing to the diffusing powders of the first diffuser and second diffuser refract or reflect the light of the image, there are light emitted at both sides of the screen. Consequently, the audiences at two sides of the twin image screen can both see the clear image. Therefore, the twin image screen of the invention could be applied to the trade show, commercial billboard, displaying board of the conference room, and etc. Besides, the thickness of the twin image screen can be made as thin as real process required, so the twin image screen can be shaped like a roll to meet the requirement of the space where the twin image screen is to be disposed.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional front projection technique;

FIG. 2 is a schematic view of the conventional rear projection technique;

FIG. 3 is an enlarged schematic diagram of a twin image screen according to a first embodiment of the invention;

FIG. 4 is a schematic diagram of a first diffuser of the twin image screen according to the first embodiment of the invention, wherein the first diffuser is formed on the transparent substrate by a spin coating process; and

FIG. 5 is an enlarged schematic diagram of a twin image screen according to a second embodiment of the invention.

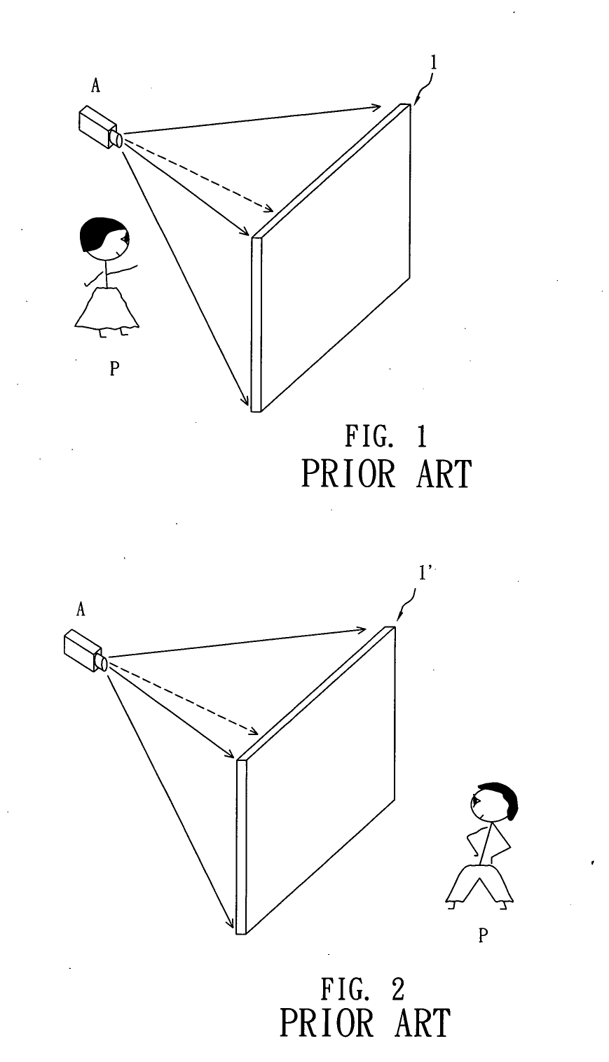

### DETAILED DESCRIPTION OF THE INVENTION

The present invention will be apparent from the following detailed description, which proceeds with reference to the accompanying drawings, wherein the same references relate to the same elements.

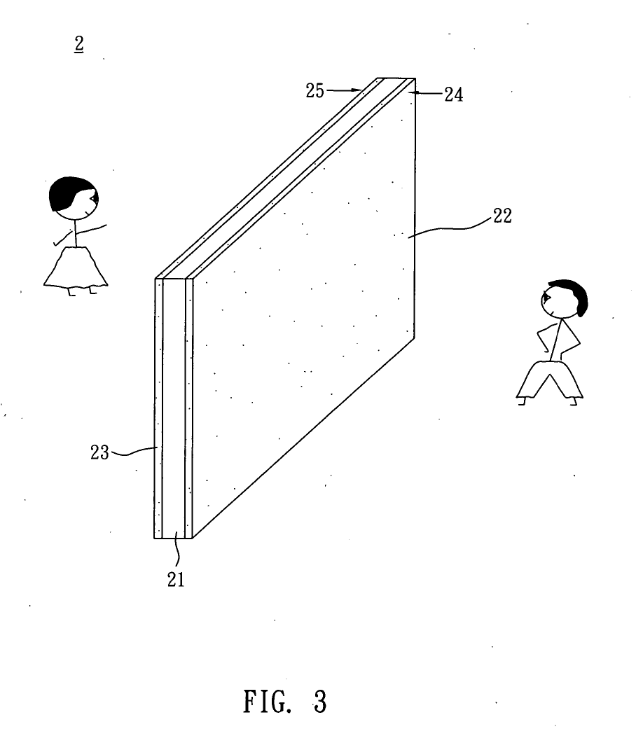

Referring to FIG. 3, a twin image screen 2 according to a first embodiment of the invention includes a transparent substrate 21, a first diffuser 22 and a second diffuser 23.

The transparent substrate 21 is made of polyethylene terephthalate (PET). Besides, the transparent substrate 21 is flexible and has a thickness approximately ranged from 100 μm to 200 μm. The thickness of the transparent substrate 21 can be make as real requirement and becomes more than 200 μm. Moreover, the transparent substrate 21 can be made of an acrylic material to enhance the strength of the transparent substrate 21 and to make the first diffuser 22 flatten, and disposed on the transparent substrate 21.

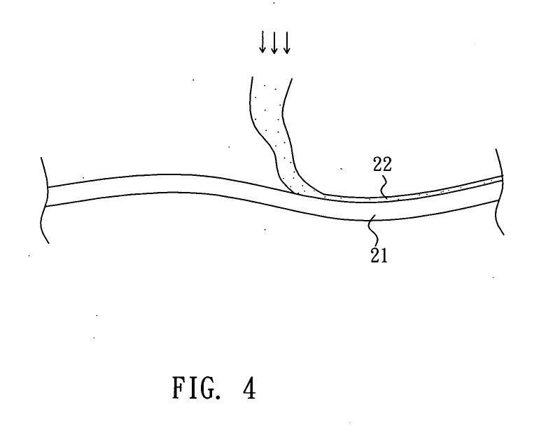

According to FIG. 3 and FIG. 4, the first diffuser 2112 is disposed at one side of the transparent substrate 21. In the embodiment, the first diffuser 21 can be formed by a scrape coating process or a spin coating process. In more details, a liquid row material of the first diffuser 22 is coated on one side of the transparent substrate 21 by a scrape coating process or a spin coating process, and the transparent substrate 21 is processed with a curing process so as to form the first diffuser 22.

In addition, the first diffuser 22 is composed of a first diffuser powder and a first resin. In this case, the first resin is made of styrene-methyl methacrylate (MS). In the current embodiment, the first diffuser powder has a particle size approximately ranged from 0.5 μm to 20 μm and a refraction index approximately ranged from 1.4 to 1.7. The first diffuser powder can be made of polycarbonate, polyacrylate, polystyrene, or their mixtures.

The second diffuser 23 is disposed at another side of the transparent substrate 21. In the embodiment, the second diffuser 23 is composed of a second diffuser powder and a second resin. In this case, the second resin is made of styrene-methyl methacrylate (MS). The second diffuser powder has a particle size approximately ranged from 0.5 μm to 20 μm and a refraction index approximately ranged from 1.4 to 1.7. The second diffuser powder can be made of polycarbonate, polyacrylate, polystyrene, or their mixtures.

In the embodiment, the second diffuser powder may be the same as the first diffuser powder. They may be respectively added into the second diffuser 23 and the first diffuser 22 in different ratios so as to adjust the brightness of two surfaces of the twin image screen 2. It is preferred to adjust the two surfaces of the twin image screen 21 to have the same brightness. In this case, the displayed image is clear, high contrast, and good color saturation. Of course, the first diffuser powder and the second diffuser powder may be different diffuser powders.

When an image is projected from a first side 24 of the twin image screen 2, a part of the projected light is reflected by the first diffuser powder of the first diffuser 22 and is then seen by the audiences opposite to the first side 24. The rest part of the projected light is refracted, penetrates the transparent substrate 21, and then reaches the second diffuser 223. In this case, a part of the light reaching the second diffuser 23 is reflected by the second diffuser 23 to the first diffuser 22, and the rest part of the light reaching the second diffuser 23 is refracted and is then seen by the audiences opposite to the second side 25 of the twin image screen 2. Since the projected light is reflected and refracted by the first diffuser 22 and the second diffuser 23, the twin image screen 2 can have larger view angle.

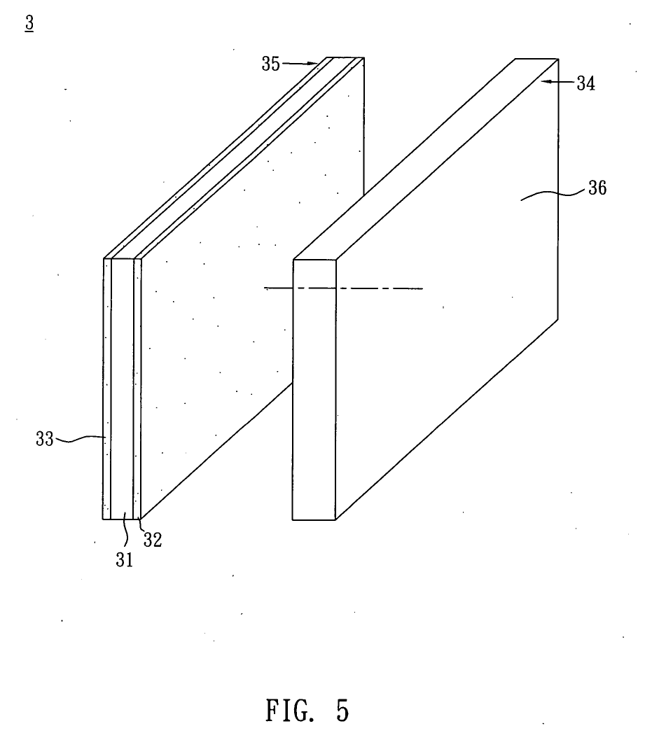

With reference to FIG. 5, a twin image screen 3 according to a second embodiment of the invention includes a transparent substrate 31, a first diffuser 32 and a second diffuser 33.

In this case, the transparent substrate 31, and the second diffuser 33 have the same functions and features.

In the current embodiment, the first diffuser 32 further has a pressure sensitive adhesive, which makes the first diffuser 32 sticky.

In the embodiment, the twin image screen 3 further includes a fixing board 36. The first diffuser 32 is bonded to the fixing board 36 with its side surface opposite to the transparent substrate 31. By this stickiness of the first diffuser 32, the second diffuser 33 and the transparent substrate 31 are bonded on the fixing board 36. As a result, the strength of the twin image screen 3 is improved, and the twin image screen 3 will not become curved owing to the sufficient thickness. In this case, fixing board 36 is made of acrylic resin or glass.

Of course, a back side adhesive can be applied to the first diffuser 32 directly, and bonds the second diffuser 33 and transparent substrate 31 to the fixing board 36.

In the embodiment, the first diffuser 32 has a dye. In this case, the color of the dye can be decided by the request of the clients. After adding the dye, the color contrast and saturation of the screen will be improved.

When an image is projected from a first side 34 of the twin image screen 3, a part of the projected light is reflected by the first diffuser powder of the first diffuser 32 and is then seen by the audiences opposite to the first side 34. The rest part of the projected light is refracted, penetrates the transparent substrate 31, and then reaches the second diffuser 33. In this case, a part of the light reaching the second diffuser 33 is reflected by the second diffuser powder back to the first diffuser 32, and the rest part of the light reaching the second diffuser 33 is refracted and is then seen by the audiences opposite to the second side 35 of the twin image screen 3.

Owing to the thickness of the first diffuser 32 and second diffuser 33 are thin, and they have a first diffuser powder and second diffuser powder respectively for refracting and reflecting light, the twin image screen 3 can have larger view angle.

In summary, the twin image screen of the invention can make the audiences at two sides of the screen to see the clear images simultaneously. Compared with the prior art, the twin image screen of the invention has the first diffuser and the second diffuser disposed at two sides of the transparent substrate. Owing to the diffusing powders of the first diffuser and second diffuser refract or reflect the light of the image, there are light emitted at both sides of the screen. Consequently, the audiences at two sides of the twin image screen can both see the clear image. Therefore, the twin image screen of the invention could be applied to the trade show, commercial billboard, displaying board of the conference room, and etc. Besides, the thickness of the twin image screen can be made as thin as real process required, so the twin image screen can be shaped like a roll to meet the requirement of the space where the twin image screen is to be disposed.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A twin image screen, comprising:
a transparent substrate;
a first diffuser disposed at one side of the transparent substrate; and
a second diffuser disposed at another side of the transparent substrate.

2. The twin image screen of claim 1, wherein the transparent substrate is made of polyethylene terephthalate (PET).

3. The twin image screen of claim 2, wherein the transparent substrate is flexible and has a thickness ranged from 100 μm to 200 μm.

4. The twin image screen of claim 1, wherein the transparent substrate is made of acrylic resin and has a thickness more than 200 μm.

5. The twin image screen of claim 1, wherein the first diffuser is composed of a first diffuser powder and a first resin, and the particle size of the first diffuser powder are ranged approximately from 0.5 to 20 μm.

6. The twin image screen of claim 5, wherein the first resin is made of styrene-methyl methacrylate (MS).

7. The twin image screen of claim 5, wherein the first diffuser powder has a refraction index ranged from 1.4 to 1.7.

8. The twin image screen of claim 1, wherein the first diffuser powder is made of polycarbonate, polyacrylate, polystyrene, or their mixtures.

9. The twin image screen of claim 1, wherein the second diffuser is composed of a second diffuser powder and a second resin, and the particle size of the second diffuser powder are ranged approximately from 0.5 to 20 μm.

10. The conference assistance unit of claim 9, wherein the second resin is made of styrene-methyl methacrylate (MS).

11. The twin image screen of claim 9, wherein the second diffuser powder has a refraction index ranged from 1.4 to 1.7.

12. The twin image screen of claim 9, wherein the second diffuser powder is made of polycarbonate, polyacrylate, polystyrene, or their mixtures.

13. The twin image screen of claim 9, wherein the first diffuser and the second diffuser powder are different.

14. The twin image screen of claim 1, wherein the first diffuser has a pressure sensitive adhesive.

15. The twin image screen of claim 1, further comprising:
a fixing board bonded with the side of the first diffuser opposite to the transparent substrate.

16. The twin image screen of claim 15, wherein the fixing board is made of acrylic or glass.

17. The twin image screen of claim 1, wherein the first diffuser has a dye to enhance color saturation.

18. The twin image screen of claim 1, wherein the second diffuser has a dye to enhance color saturation.
